(19) United States
(12) Patent Application Publication
(10) Pub. No.: US 2026/0105933 A1
(43) Pub. Date: Apr. 16, 2026

(54) VARIABLE HEIGHT MEDIA AND SPACER COMBINATION

(71) Applicant: Seagate Technology LLC, Fremont, CA (US)

(72) Inventors: Pow Ming Yap, Singapore (SG); Yong Han Song, Singapore (SG); Jiho Hwang, Singapore (SG); Chun Hong Jing, Singapore (SG)

(21) Appl. No.: 18/915,898

(22) Filed: Oct. 15, 2024

(51) Int. Cl. G11B 25/04; G11B 17/038

(52) U.S. Cl. CPC G11B 25/043; G11B 17/038

(57) ABSTRACT

An assembly includes a data storage disk and a spacer ring. The data storage disk includes a disk surface and first and second disk steps. The disk surface defines a x-y plane and includes a plurality of data tracks surrounding a first central opening. The first disk step is disposed proximate the first central opening at a first disk step level measured in a z direction from the disk surface. The second disk step is disposed proximate the first central opening at a second disk step level that is different from the first disk step level. The spacer ring includes a ring surface and first and second ring steps. The ring surface surrounds a second central opening. The first and second ring steps are disposed proximate the second central opening at first and second ring step levels, respectively. In the assembly, the disk surface faces the ring surface.

### SUMMARY

In one aspect, an assembly comprises a first data storage disk and a first spacer ring. The first data storage disk comprises a disk surface, a first disk step and a second disk step. The disk surface defines a x-y plane and comprises a plurality of data tracks surrounding a first central opening. The first disk step is disposed proximate the first central opening at a first disk step level measured in a z direction from the disk surface. The second disk step is disposed proximate the first central opening at a second disk step level measured in the z direction from the disk surface. The first disk step level is different from the second disk step level. The first spacer ring comprises a ring surface, a first ring step and a second ring step. The ring surface surrounds a second central opening. The first ring step is disposed proximate the second central opening at a first ring step level measured in the z direction from the ring surface. The second ring step is disposed proximate the second central opening at a second ring step level measured in the z direction from the ring surface. In the assembly, the disk surface faces the ring surface.

This summary and the Abstract are provided to introduce concepts in simplified form that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE DRAWINGS

The disclosed subject matter will be further explained with reference to the attached figures, wherein like structure or system elements are referred to by like reference numerals throughout the several views. All descriptions are applicable to like and analogous structures throughout the several embodiments, unless otherwise specified.

FIG. 1 is a top perspective view of an exemplary data storage device.

FIG. 2 is a cross sectional view through the disk stack of FIG. 1, taken through line 2-2.

FIG. 3 is a partial cross sectional view of the DSD of FIG. 1, taken through line 3-3.

FIG. 4A is a perspective view of a first exemplary spacer ring of the current disclosure.

FIG. 4B is a perspective view of a first exemplary media disk of the current disclosure.

FIG. 5A is an enlarged view of a portion of the spacer ring of FIG. 4A.

FIG. 5B is an enlarged view of a portion of the media disk of FIG. 4B.

FIG. 6A is a flattened side view of the step profile of the spacer ring of FIG. 4A.

FIG. 6B is a flattened side view of the step profile of the media disk of FIG. 4B.

FIG. 7A is a flattened side view of the first exemplary spacer ring and media disk combination in a minimum height configuration.

FIG. 7B is a flattened side view of the first exemplary spacer ring and media disk combination in a nominal height configuration.

FIG. 7C is a flattened side view of the first exemplary spacer ring and media disk combination in a maximum height configuration.

FIG. 7D is a variation of the spacer ring and media disk combination in which a clearance fit is provided between the components.

FIG. 8A is a side elevation view similar to FIG. 3, but with the spindle shaft removed to illustrate a case in which a spacer and media stack may lead to desirable positions of a disk relative to a ramp.

FIG. 8B illustrates how the combination of the current disclosure can be manipulated to solve the ramp and disk issue of FIG. 8A.

FIG. 9A is a perspective view of a second exemplary media disk.

FIG. 9B is an enlarged view of a portion of FIG. 9A, taken at line 9B-9B.

FIG. 10A is a top view of a third exemplary spacer ring.

FIG. 10B is a top view of a third exemplary media disk for use with the spacer ring of FIG. 10A.

FIG. 11A is a top view of a fourth exemplary spacer ring.

FIG. 11B is a top view of a fourth exemplary media disk for use with the spacer ring of FIG. 11A.

While the above-identified figures set forth one or more embodiments of the disclosed subject matter, other embodiments are also contemplated, as noted in the disclosure. In all cases, this disclosure presents the disclosed subject matter by way of representation and not limitation. It should be understood that numerous other modifications and embodiments can be devised by those skilled in the art that fall within the scope of the principles of this disclosure.

The figures may not be drawn to scale. In particular, some features may be enlarged relative to other features for clarity. Moreover, where terms such as above, below, over, under, top, bottom, side, right, left, vertical, horizontal, etc., are used, it is to be understood that they are used only for ease of understanding the description. It is contemplated that structures may be oriented otherwise.

### DETAILED DESCRIPTION

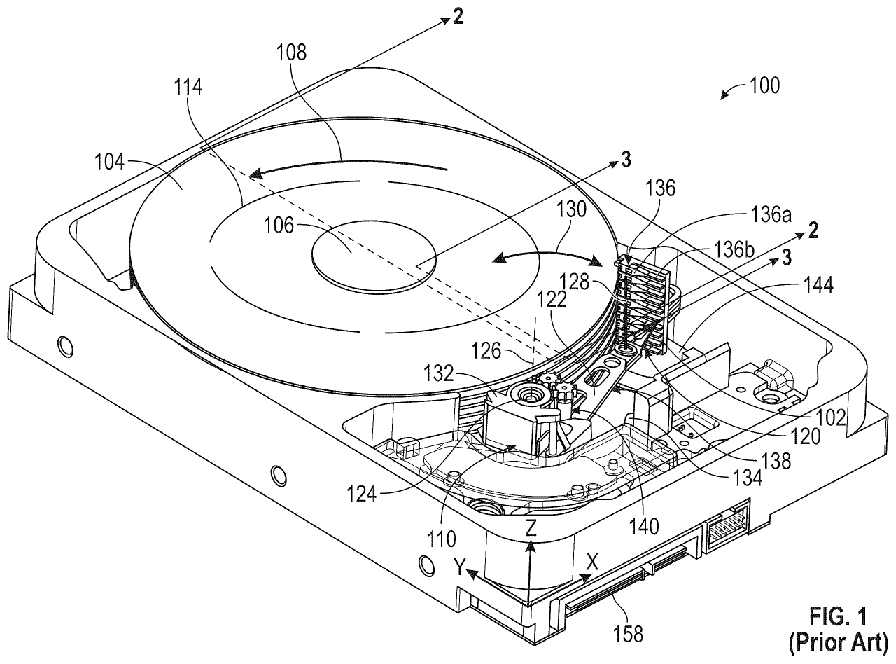

The present disclosure generally relates to data storage devices (DSD) that utilize magnetic storage media, such as hard disks. FIG. 1 shows an illustrative embodiment of a DSD 100. The illustrated DSD 100 and is provided for illustration purposes only. Embodiments of the present disclosure are not limited to any particular type of DSD such as shown in FIG. 1. Embodiments of the present disclosure are illustratively practiced within any number of different types of DSDs.

It should be noted that the same reference numerals are used in different figures for the same or similar elements. All descriptions of an element also apply to all other versions of that element unless otherwise stated. It should also be understood that the terminology used herein is for the purpose of describing embodiments, and the terminology is not intended to be limiting. Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that, unless indicated otherwise, any labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” “intermediate” and the like are used for convenience and are not intended to imply, for example, any particular fixed location, orientation, or direction. Instead, such labels are used to reflect, for example, relative location, orientation, or directions. It should also be understood that the singular forms of “a,” “an,” and “the” include plural references unless the context clearly dictates otherwise.

It will be understood that, when an element is referred to as being “connected,” “coupled,” or “attached” to another element, it can be directly connected, coupled or attached to the other element, or it can be indirectly connected, coupled, or attached to the other element where intervening or intermediate elements may be present. In contrast, if an element is referred to as being “directly connected,” “directly coupled” or “directly attached” to another element, there are no intervening elements present. Drawings illustrating direct connections, couplings or attachments between elements also include embodiments, in which the elements are indirectly connected, coupled or attached to each other.

Four specific embodiments of components of a combination are described. For example, in some cases different embodiments of a media disk will be differentiated by referring to the first embodiment with reference number 152a, the second embodiment with reference number 152b, the third embodiment with reference number 152c, and the fourth embodiment with reference number 152d. However, in many aspects, the media disks are similar; descriptions of media disk 152, 152a, 152b, 152c or 152d apply to all embodiments unless otherwise specified. This convention also applies to other similarly numbered elements.

FIG. 1 is a schematic illustration of a data storage device 100 in which one or more heads 102 may be positioned over or under storage media 104 to read data from and/or write data to the data storage media 104. In the embodiment shown in FIG. 1, the data storage media 104 are rotatable data storage disks, with each disk 104 having opposing surfaces that serve as data storage surfaces. For read and write operations, a spindle 106 rotates the stack of media disks 104 as illustrated by arrow 108. An actuator mechanism 110 positions the heads 102 relative to data tracks 114 on the rotating media 104 between an inner diameter (ID) and an outer diameter (OD). Both the spindle 106 and actuator mechanism 110 are connected to and operated through drive circuitry. Connector 158 may be used to electrically connect DSD 100 to a printed circuit board assembly (PCBA) of a data center rack, enclosure, or chassis that includes a plurality of DSDs 100 mounted using a vertical (i.e., tombstone or toast) architecture, for example.

In general, in order to keep read/write heads 102 from landing on disks 104 in a data storage device 100 when, for example, power is removed from the data storage device 100, and to prevent the heads 102 from colliding with outer edges of the disks 104 during load and unload operations, a head support ramp assembly 136 is provided adjacent to the OD of the disks 104. In an exemplary data storage device 100, a number of heads 102 is less than a number of disk 104 surfaces. In an exemplary embodiment, each disk 104 has a top data storage surface and a bottom data storage surface.

Each of heads 102 is coupled to the actuator mechanism 110 through a suspension assembly that includes a load beam 120 connected to an actuator arm 122 of the mechanism 110, for example through a swage connection. The actuator mechanism 110 is rotationally coupled to base 144 through a bearing 124 to rotate about axis 126. The actuator mechanism 110 moves the heads 102 in a cross-track direction as illustrated by arrow 130. Each of the heads 102 includes one or more transducer elements coupled to head circuitry through a flex circuit 134. The actuator mechanism 110, the load beam 120 and the actuator arm 122 are collectively referred to as a head stack assembly (HSA) 138. In data storage device 100 of FIG. 1A, the HSA 138 may be moved along axis 126 to different height positions under motive of an elevator 140 to interact with data storage surfaces of different disks of the stack of disks 104 carried on spindle 106.

As shown in FIG. 1, in an exemplary embodiment, head support ramp assembly 136 supports a tab at a head end of load beam 120 when the HSA 138 is moved away from the data storage disk(s) 104. In some embodiments, head support ramp 136 includes a first ramp portion 136a adjacent to the OD of the data storage disks 104 and a second ramp portion 136b adjacent to the first ramp portion 136a. In order to move the HSA 138 from either an upper position to a lower position or from a lower position to an upper position, the HSA 138 is first rotated about axis 126, or otherwise moved in the x-y plane, until its tab is supported on the moveable portion 136b of the head-support ramp assembly 136. Then, the HSA 138 and the moveable portion 136b are moved in unison vertically (for example, in a z direction). An entire ramp 136 or a portion thereof can also be moved in the x-y plane off the disk stack, such as by retraction, flexing, or rotation, for example. Other ramp configurations can also be used, such as those described in the following commonly owned patents, which are hereby incorporated by reference: U.S. Pat. No. 11,094,347, entitled “Split Ramp for Data Storage Devices;” and U.S. Pat. No. 11,348,610, entitled “Movable Ramp with Arm Engaging Bracket for an Elevator Drive on a Magnetic Disk Recording Device.” Thus, the HSA 138 moves up and down to access data from multiple disk surfaces in the DSD 100.

For use of heads 102 for reading and writing data relative to disk 104, actuator 110 is activated to rotate the actuator arm 122, to thereby move the head end of HSA 138 off of the head support ramp assembly 136 and to the disk 104. To move the head end of HSA 138 onto or off a disk 104, arm 122 rotates about cylindrical bearing 124 and pivot axis 126. As shown in FIG. 1, rotation of arm 122 about pivot axis 126 results in moving the head end of HSA 138 in an arc-shaped cross track direction 130 that is not truly on a radius of the disk 104. Accordingly, with a rotary actuator arm 122, in some positions of the head 102 on disk 104, there is some skew between the head orientation and the true track orientation of a track 114. Thus, in some embodiments, load beam 120 rotates relative to the actuator arm 122 at a second pivot axis 128 to reduce or eliminate any skew angle and align one or more heads 102 with a selected track 114. In an exemplary embodiment, HSA 138 is able to position head 102 relative to disk 104 in a selected cross disk position along arc 130 (about a first pivot axis 126) and with a corrected zero skew orientation of the head 102 relative to any particular track 114 due to rotation of load beam 120 relative to actuator arm 122 about a second pivot axis 128. Additional details on a suitable arm configuration with a second pivot are described in the following commonly owned patent, which is hereby incorporated by reference: U.S. Pat. No. 11,468,909, entitled “Zero Skew with Ultrasonic Piezoelectric Swing Suspension.” More details of the illustrated data storage device 100 are provided in commonly owned US Patent Application Publication 2024/0221780 for “Single Arm Stepper Elevation System.”

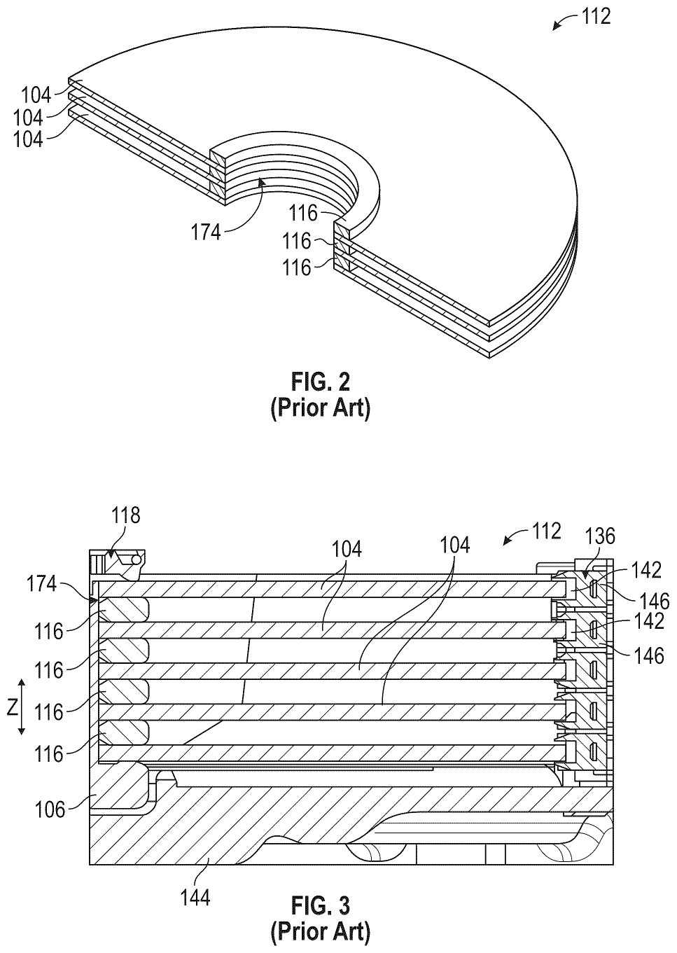

FIG. 2 is a cross sectional view, taken along line 2-2 of FIG. 1, of a stack 112 of alternating disks 104 and spacers 116. In FIG. 2, the stack 112 has been removed from the spindle 106 so that spindle hole 174 is visible. FIG. 3 is a partial cross sectional view taken at line 3-3 of FIG. 1. Typically, multiple center-open disks 104 and spacer rings 116 are alternately stacked on a spindle motor hub 106. The hub 106, defining the core of the stack, serves to align the disks 104 and spacer rings 116 around a common rotation axis. Collectively the disks 104, spacer rings 116 and spindle motor hub 106 define a disc pack assembly. Spacer rings 116 separate adjacent disks 104 within a disc stack 112 along the z direction. Typically each spacer ring 116 has a defined thickness in the z direction to accommodate HSA 138 in between the two disks separated thereby. The spacer ring 116 is located at the inner diameter of the disk 104, inward of the readable portion of the disk that contains tracks 114.

In the illustrated embodiment, clamp 118 holds the stack 112 against a foot of the spindle motor hub 106. As shown on a right side of FIG. 3, the outer diameter of each disk 104 is suspended in gaps 142 of head support portions 146 of head support ramp 136. In manufacturing, it is impossible to obtain perfectly consistent dimensions in components with actual measurements equal to targeted values. The dimensions will vary, and such variations or tolerances must be taken into account during the design, fabrication and manufacturing phases of the data storage device 100. When multiple components are used, these variations will be additive. The combined effects of dimensional variations in stacked components can cause undesirable misalignment between parts of the data storage device 100.

One way in which to increase a storage capacity of a data storage device 100 is to increase the number of disks 104 therein. As higher numbers of media disks, and therefore higher corresponding numbers of head stack assemblies 138, are fitted into a data storage device 100, their stack-up heights are likely to vary more widely than is acceptable when spacer rings 116 of a consistent height are used in the stack 112. One of the ways in which this problem is addressed is to include spacers 116 of different nominal values or heights in the z direction. In one method of assembling a data storage device, the height of each media disk 104 is measured while it is being installed, and any variation in height can be minimized by using a different spacer of the desirable thickness (or vertical dimension in the z direction) to compensate for variation in the thickness of the media disk 104. This method is effective in leading to the desired result but is taxing on logistics and manufacturing. It requires the use and organization of multiple spacer rings 116 of different thicknesses. Thus, in the assembly process, there is an increased probability of mixing up these different height spacers, which exacerbates the time for assembly. Additionally, in a case wherein automated robotic machinery is used to select the correct spacer of a desired height depending on a measured disk height, the robotic machinery will have a bigger footprint and more complexity to accommodate all the variations in spacer components. These issues also drive up costs associated with the data storage device 100.

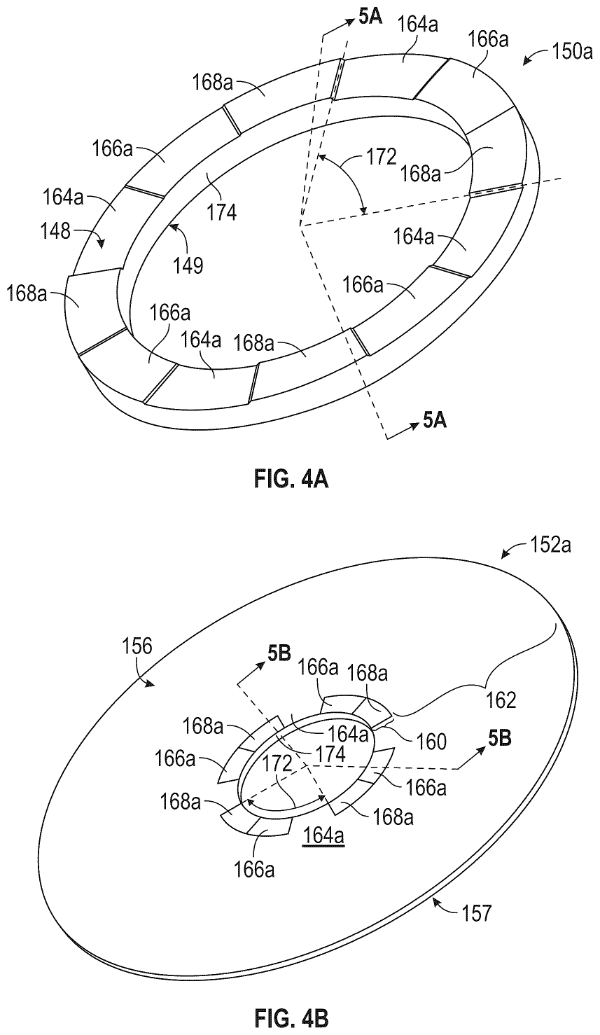

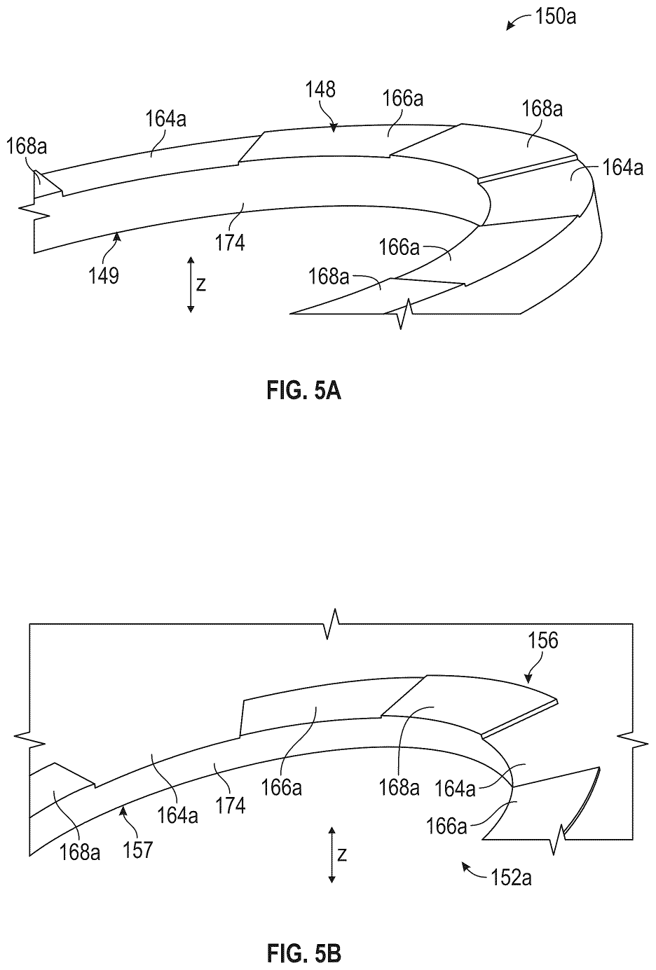

To address these issues, FIGS. 4A and 4B show perspective views of a spacer ring 150a and a media disk 152a that together are used in a combination 154a to effectively eradicate the logistics and manufacturing issues discussed above associated with using spacers of different heights. This leads to increased efficiency in inventory and manufacturing, and can thereby lead to cost savings. In an exemplary embodiment, disk 152 is similar to disk 104 but has variable height features at its inner annular zone 160. FIGS. 5A and 5B show enlarged portions of marked sections of FIGS. 4A and 4B.

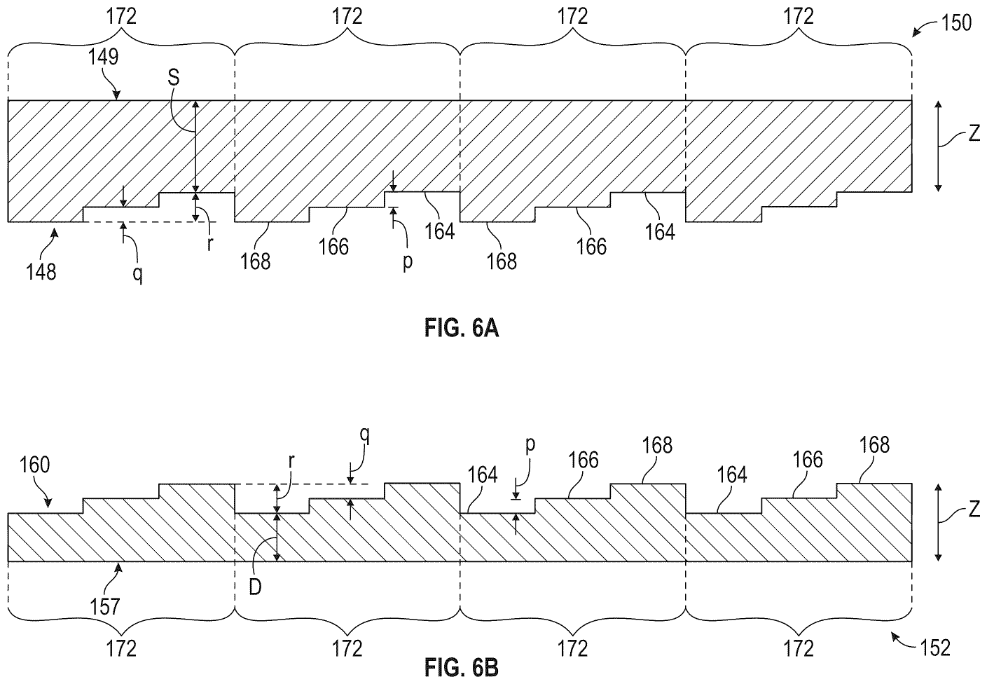

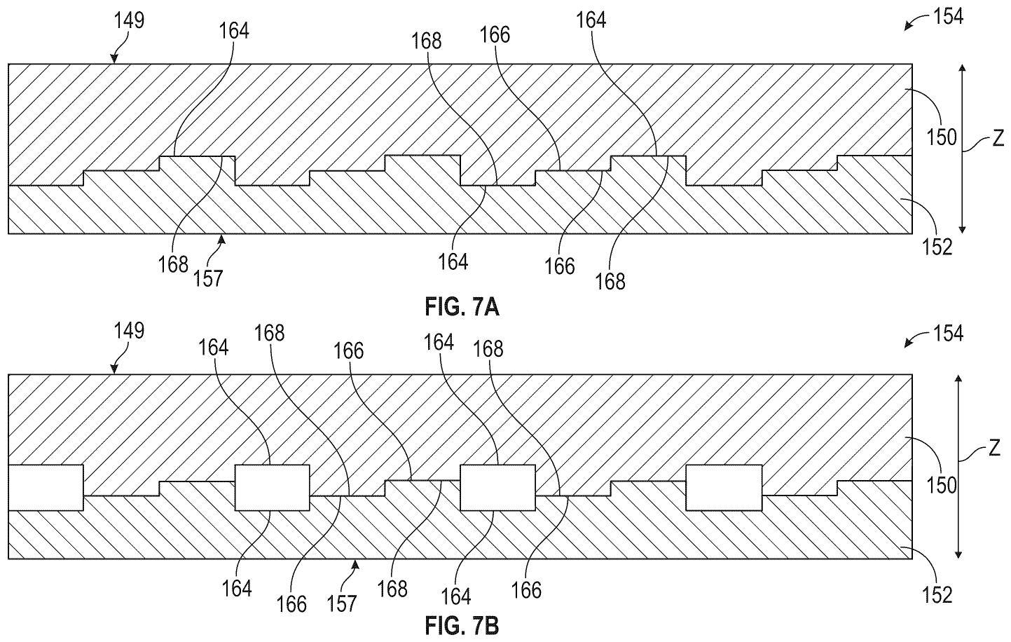

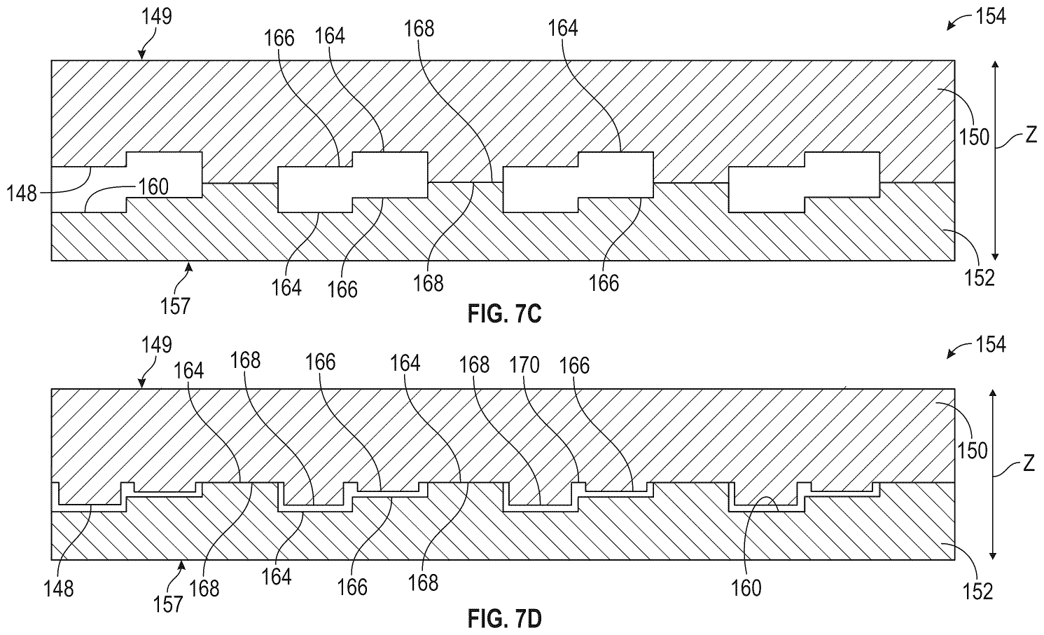

FIG. 4A is enlarged relative to FIG. 4B. In reality, the central hole 174 of spacer ring 150 is the same size as the central hole 174 of disk 152. Notably, FIGS. 4A and 5A show the spacer ring 150a in an upside down configuration. It is to be understood that in use in the combination 154, the surface 148 would be flipped to face and interface with the top surface 156 of media disk 152 (as shown in FIGS. 6A-7D, for example). On disk 152a, the inner annular zone 160 has a top surface that is configured to interface with the bottom surface 148 of spacer ring 150a. This inner annular zone 160 generally has the same radial extent in the x-y plane as the width of spacer ring 150a. Moreover, this inner annular zone 160 is positioned inward of the data zone 162 on which the data tracks 114 are positioned.

In an exemplary embodiment, each of the bottom surface 148 of spacer ring 150 and the inner annular zone 160 of disk 152 has portions or steps of varying z height dimension. For example, as shown in FIGS. 5A and 5B, each has a lowest portion 164, a nominal height portion 166, and a highest portion 168. In the illustrated embodiments, each of the variable height portions is configured as an arc shaped step, though other configurations are also possible. In the illustrated embodiment, surface 148 of spacer ring 150a has four serially repeating arc sections 172, in which a clockwise progression of steps is lowest 164, nominal 166, highest 168. Likewise, inner annular surface of disk 152a has four serially repeating arc sections 172, in which a clockwise progression of steps is lowest 164, nominal 166, highest 168. Thus, when surface 148 is flipped to face surface 156 (see FIGS. 6A-7D), on spacer ring 150, a left-to-right progression of steps is highest 168, nominal 166, lowest 164.

FIGS. 6A and 6B are flattened side schematic elevation views of the interacting surfaces 148, 160 of an exemplary spacer ring 150 and of annular zone 160 of disk 152, respectively. By “flattened,” the disclosure means that these figures (and others) are presented so that the circular circumference of the spindle hole 174 of each of spacer ring 150 and media disk 152 is presented as a rectangular face to more easily show the interactions between the step features of the these components. In an exemplary embodiment of both spacer ring 150 and disk 152, a height difference in the z direction between the lowest portion 164 and the nominal portion 166 is designated as dimension p. A height difference between the nominal portion 166 and the highest portion 168 is designated as dimension q. The height difference in the z direction between the lowest portion 164 and the highest portion 168 is designated as dimension r. In the illustrated embodiment of FIGS. 6A and 6B, each step height is the same, so that p equals q, and r equals 2p, which equals 2q. However, the heights of each of the steps can be different so that p does not equal q, though r will equal p plus q. In an exemplary embodiment, spacer ring 150 has a height dimension S between its top surface 149 and the lowest portion 164. In an exemplary embodiment, disk 152 has a height dimension in the z direction of D between the bottom surface 157 and the lowest portion 164.

FIG. 7A is a side schematic view showing a combination 154, wherein the combined vertical height of spacer ring 150 and disk 152 is at a minimum. In this configuration, a total height in the z dimension between top surface 149 of spacer ring 150 and bottom surface 157 of disk 152 is S plus D plus r. In this configuration, each of the lowest portions 164 of spacer ring 150 interfaces each of the highest portions 168 of media disk 152, and vice versa. Additionally, the intermediate height portions 166 of spacer ring 150 face and interface with the intermediate portions 166 of disk 152.

FIG. 7B is a side schematic view showing a combination 154, wherein the combined vertical height of spacer ring 150 and disk 152 is at a nominal (intermediate) height. In this configuration, a total height in the z dimension between top surface 149 of spacer ring 150 and bottom surface 157 of disk 152 is S plus D plus r plus p, which is equal to S plus D plus r plus q in this example. In this configuration, each of the nominal portions 166 of spacer ring 150 interfaces each of the highest portions 168 of media disk 152, and vice versa. Additionally, the lowest height portions 164 of spacer ring 150 face but do not contact the lowest height portions 164 of disk 152.

FIG. 7C is a side schematic view showing a combination 154, wherein the combined vertical height of spacer ring 150 and disk 152 is at a maximum height. In this configuration, a total height in the z dimension between top surface 149 of spacer ring 150 and bottom surface 157 of disk 152 is S plus D plus 2r and equalities thereof. In this configuration, each of the highest portions 168 of spacer ring 150 interfaces each of the highest portions 168 of media disk 152. Additionally, the lowest height portions 164 of spacer ring 150 face but do not contact the nominal portions 166 of disk 152, and vice versa.

FIG. 7D is similar to FIG. 7A in showing a combination 154, wherein the combined vertical height of spacer ring 150 and disk 152 is at a minimum. However, in this case, dimension r of disk 152 is greater than dimension r of spacer ring 150. Additionally, dimension p of disk 152 is greater than dimension p of spacer ring 150. This creates a clearance gap between surfaces 148, 156 at those locations, allowing for proper fit even in the presence of particulate debris. Moreover, in FIG. 7D, on bottom surface 148 of spacer ring 150, groove 170 is provided between each intermediate portion 166 and an adjacent highest portion 168, wherein groove 170 has the same z dimension position as lowest portion 164. Accordingly, the additional clearance provided by groove 170 further facilitates non-interference between the facing surfaces 148, 156, even in the event debris is caught between the two surfaces. While one configuration is shown, the clearances can be provided with different height relationships between the parts than illustrated. Additionally, it is to be understood that any descriptions of spacer ring 150 can instead be applied to disk 152, and vice versa.

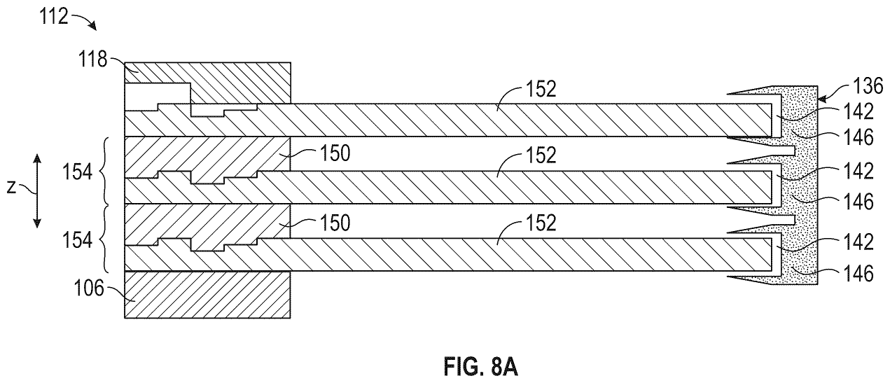

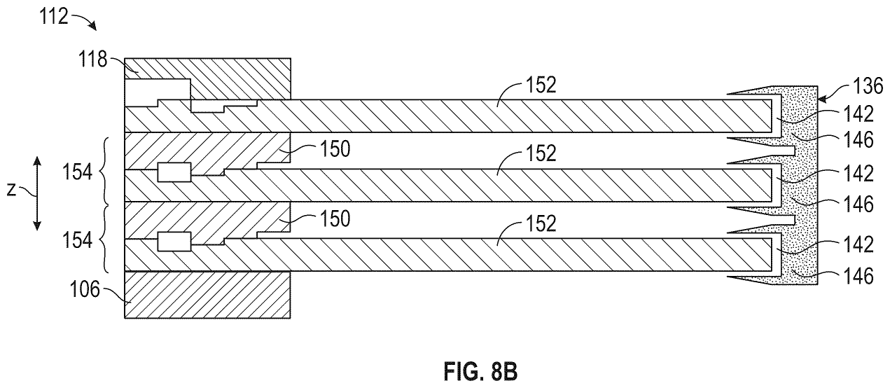

FIG. 8A is similar to FIG. 3; it is to be understood that stack 112 can have any number of disks 152 with interleaved spacer rings 150. Moreover, while a disk 152 is shown at the top of the stack with no facing spacer ring, a conventional disk 104 can instead be used in this position. FIG. 8A differs from FIG. 3 in that it shows a situation in which two combinations 154 having the minimum spacing of FIG. 7A lead to a stack 112 in which the outer diameters of some of the disks 152 do not have a desired vertical position with respect to the head support portions 146 of ramp 136. For example, the top disk 152 nearly contacts the bottom of its respective head support portion 146, and the middle disk is closer to the bottom than to the top of its respective head support portion 146

As shown in FIG. 8B, when the complementary spacer and disk components of the disclosed combinations 154 are used, this situation can be remedied without switching out spacer or disk components, but merely by manipulating their relative orientations to obtain the nominal height configuration of FIG. 7B. The selection of the vertical height of a combination 154, such as in the three different configurations of FIGS. 7A, 7B, and 7C, is achieved in an exemplary embodiment by mutual rotation of the spacer ring 150 and the media disk 152 about the vertical rotation axis of spindle 106 (at the center of hole 174). Based on the live measurements of the current media disk 152, the positions of the next spacer ring 150 can be rotationally adjusted about the spindle rotation axis so that the height of the combination 154 supports the next media disk 152 as close to the targeted value relative to the ramp portions 146 as possible. As shown in FIG. 8B, by using the nominal combination configuration of FIG. 7B at each combination 154, each media disk 152 is raised so that it is relatively centered in gap 142 of its respective ramp portion 146. While the two illustrated combinations 154 have the same configuration, it is to be understood that in a single stack 112, any number of similar or different combinations 154 can be used. The selection of which combination 154 (and the corresponding mutual rotational orientations of spacer ring 150 and disk 152) will depend on the measured position of a disk 152 of the stack 112 and the desired vertical height of the next disk 152 in relation to the current disk 152 and the ramp 136.

To aid in precise rotational orientation of the spacer ring 150 and media disk 152 of a combination 154, markings that are readable by a human and/or machine can be provided on each of these components. For example, on the media disk 152, a magnetic index mark can be used. For the spacer 150, a small depression may be provided, for example. The relative rotational orientations of the spacer rings 150 and media disks 152 of a stack 112 are maintained by compressive pressure between the clamp 118 and the foot of the spindle motor hub 106. In general, for a 3.5 inch hard disk drive, a clamp force between about 100 and 200 kilograms force is sufficient so that the rotational positions of each combination 154 is maintained even in the event of vibrations and shock.

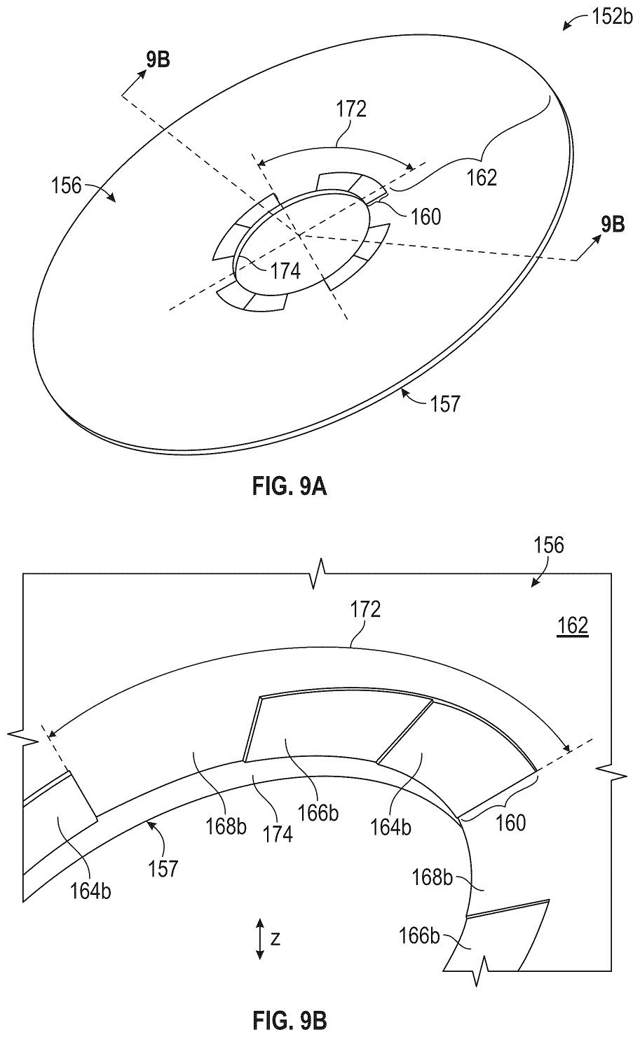

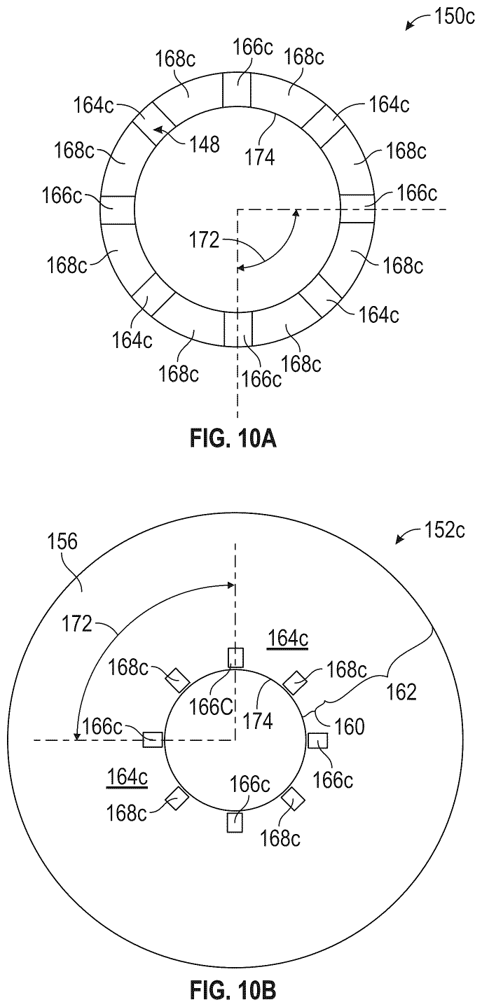

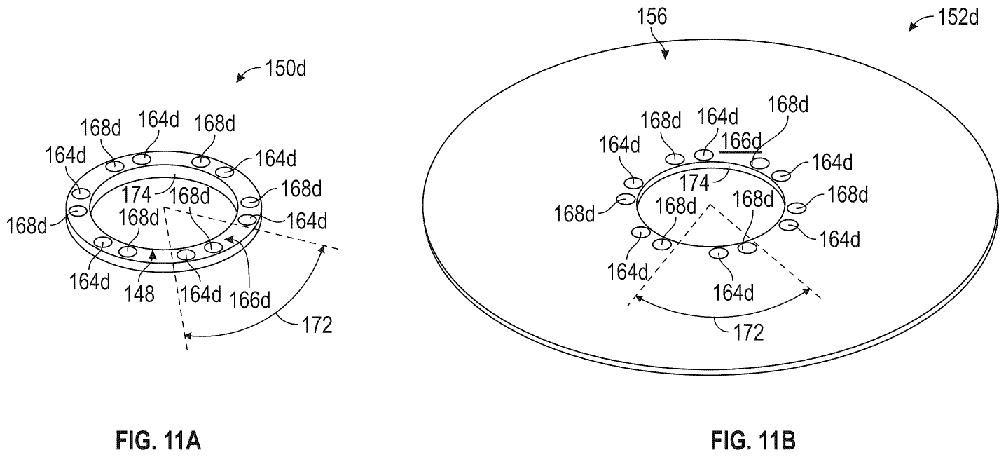

As shown in FIGS. 4B and 5B, the lowest portion 164a is at the same z direction plane as the data zone 162 of the disk 152a. While the arcuate step configurations of FIGS. 4A through 5B present one suitable configuration, other constructions are also suitable. For example, FIGS. 9A and 9B show a second exemplary embodiment of a media disk 152b in which the highest portion 168b is at the same z direction plane as the data zone 162. The nominal portion 166b is recessed downward from the data zone plane, and the lowest portion 164b is recessed lower than the nominal plane of 166b. Inner annular surface 160 of disk 152a has four serially repeating arc sections 172, in which a clockwise progression of steps is highest 168, nominal 166, lowest 164. Thus, a spacer ring 150 that would be compatible would be similar to that of FIGS. 4A and 5A, except that a clockwise progression of its steps is highest 168, nominal 166, lowest 164. Thus, when such a spacer ring 150 is flipped, the left-to-right progression of steps is lowest 164, nominal 166, highest 168 to oppose the disk 152b. While sets of cooperating spacer rings 150 and media disks 152 are described, it is to be understood that the spacer ring 150 of any embodiment can suitably be used with a media disk 152 of another embodiment as long as the low, nominal, and high portions are structurally compatible, even if they are not commonly shaped. For example, see the differently shaped steps of FIGS. 10A-11B.

In the previously discussed first and second embodiments, each of the portions of varying heights 164, 166, 168 has the same circumferential extent about spindle hole 174 of either spacer ring 150 or the inner annular zone 160 of media disk 152. However, as shown in FIG. 10A, in the third exemplary spacer ring 150c, each of the lowest portion 164c and nominal portion 166c has a common or same circumferential arc extent; however, each of the highest portions 168c covers a larger circumferential arc than the portions 164c, 166c. As illustrated, an area of each of the highest portions 168c on the bottom surface 148 is about twice the surface area of each lowest portion 164c or each nominal portion 166c. As shown in FIG. 10B, in the third exemplary media disk 152c, the lowest portions 164c are at a same z direction plane as the data zone 162. Radially smaller sections of nominal portion 166c and highest portion 168c are provided as raised portions on surface 156c.

Referring to FIGS. 9A and 9B, each inner annular zone 160 has a plurality of repeating arc sections 172, wherein each arc section 172 has a pattern of steps, such as a highest portion 168b adjacent a nominal portion 166b, which is adjacent a lowest portion 164b, which is adjacent a highest portion 168b, which is adjacent a nominal portion 166b, etc. In each of the first and second embodiments 152a, 152b of a media disk, there are four such circumferentially repeating arc sections 172. In contrast, in the third exemplary embodiment of FIGS. 10A and 10B, the pattern of differently leveled portions of each repeated arc section does not have steps that consistently increase or decrease about a circumference of the spindle hole 174 of ring 150c or of inner annular portion 160c of disk 152c. Rather, the positions of the portions 164c, 166c, 168c are symmetrical about the x and y axes in the plane of the disk and ring. Each of the highest portions 168 should be sized and shaped to fit into the recessed or lowest portions 164c of the interfacing surface of the complementary components, whether it is the spacer ring 150 or the media disk 152.

FIGS. 11A and 11B show perspective views of a spacer ring 150d and media disk 152d in a fourth exemplary embodiment, wherein the steps are circular. The circular protrusions 168d have a diameter that is less than or equal to a diameter of each of the interfacing circular recesses 164d to ensure proper meshing when these surfaces face each other. In the illustrated embodiments, a primary surface 148, 156 is at the nominal height 166, while recesses 164d are recessed from the surface 148, 156, and protrusions 168d extend from the surface 148, 156. Moreover, six repeating arc sections 172 are used on each of the components 150d, 152d.

The various described embodiments illustrate that the shapes, profiles and positions of the different height portions 164, 166, 168 can differ from the specifically illustrated embodiments while still applying the described principles. Referring to FIGS. 6A and 6B, while the heights of the steps are equal to each other as illustrated, the deltas and dimensions between the portions 164, 166, 168 can vary so that they are unequal to each other in other implementations. Moreover, as discussed with reference to FIG. 7D, a height of a step of the spacer ring 150 need not be equal to a corresponding step of the disk 152.

In all embodiments, the different depths in the z direction of the steps (different height portions 164, 166, 168) can be provided on each of the spacer ring 150 and media disk 152 by additive methods such as coating or other deposition techniques, or by removal methods such as electro discharge machining (EDM) or grinding, or by a combination of additive and removal methods. Machining via computer aided manufacturing is also another potential method for fabrication of the components of combination 154, including spacer ring 150 and media disk 152. Where additive methods are used, it is recommended for the materials of the added step to be structurally and chemically compatible with the material of the underlying substrate. For example, if aluminum is used for the media disk 152, increased height steps at the inner annular zone 160 can be formed by an electroless nickel-phosphorous (Ni—P) coating.

While three sets of three steps of different heights are illustrated and described, the described concepts also apply to sets and arc sections of more or fewer steps or portions of varying heights. For example, if four different heights of steps or portions are provided, a finer range of height variation can be achieved. Moreover, a greater overall difference between the minimal height and the maximum height can be achieved for a combination 154 in a case where dimension r (the vertical distance between the lowest portion 164 and the highest portion 168) is increased.

Referring to FIGS. 6A and 6B, while surfaces 148 and 156 are shown with the step profile and surfaces 149, 157 are shown as smooth, it is contemplated that the outside surfaces 149, 157 can also be stepped or profiled in another implementation.

Exemplary, non-limiting embodiments of an assembly are described. In an exemplary embodiment, an assembly comprises a first data storage disk 152 and a first spacer ring 150. The first data storage disk 152 comprises a disk surface 156, a first disk step (one of 164, 166, 168) and a second disk step (another of 164, 166, 168). The disk surface 156 defines a x-y plane and comprises a plurality of data tracks 114 surrounding a first central opening 174. The first disk step is disposed proximate the first central opening 174 at a first disk step level measured in a z direction from the disk surface 156. The second disk step is disposed proximate the first central opening 174 at a second disk step level measured in the z direction from the disk surface 156. The first disk step level is different from the second disk step level. The first spacer ring 150 comprises a ring surface 148, a first ring step (one of 164, 166, 168) and a second ring step (another of 164, 166, 168). The ring surface 148 surrounds a second central opening 174. The first ring step is disposed proximate the second central opening 174 at a first ring step level measured in the z direction from the ring surface 148. The second ring step is disposed proximate the second central opening at a second ring step level measured in the z direction from the ring surface 148. In the assembly, the disk surface 156 faces the ring surface 148.

In an exemplary embodiment, the first disk step level equals the first ring step level; see FIGS. 6A-7 for example, where p of FIG. 6B equals p of FIG. 6A. In an exemplary embodiment, the first disk step level is different from the first ring step level; see FIG. 7D, for example. In an exemplary embodiment, the second disk step level equals two times the first disk step level; see FIG. 6B, for example, where r equals 2p. In an exemplary embodiment, a groove 170 is positioned between the first ring step and the second ring step, as shown in FIG. 7D.

In an exemplary embodiment, at least one of the first or second disk steps is recessed from the disk surface. In an exemplary embodiment, the first disk step 164 is recessed from the disk surface and the second disk step 168 is raised from the disk surface 156 (which is at intermediate height 166), as shown in FIG. 11B.

In an exemplary embodiment, the first data storage disk 152 comprises a plurality of arc sections 172, wherein a first arc section of the plurality of arc sections comprises: a first portion of the disk surface; the first disk step adjacent the first portion of the disk surface; and the second disk step adjacent the first disk step. In an exemplary embodiment, the plurality of arc sections 172 repeat in series around the first central opening 174, as shown in FIGS. 4B, 9A and 11B.

In an exemplary embodiment, at least one of the first data storage disk 152 or the first spacer ring 150 is symmetrical about the x-axis or the y-axis, as shown in FIGS. 10A and 10B. In an exemplary embodiment, at least one of the first data storage disk 152 or the first spacer ring 150 is symmetrical about both the x-axis and the y-axis, as shown in FIGS. 10A and 10B. In an exemplary embodiment, at least one of the first or second disk steps is rectangular, as shown in FIG. 10B. In an exemplary embodiment, at least one of the first or second disk steps is circular, as shown in FIG. 11B. In an exemplary embodiment, at least one of the first or second ring steps is circular, as shown in FIG. 11A.

In an exemplary embodiment, the first disk step extends a first circumferential distance along the first central opening 174; and the second disk step extends a second circumferential distance along the first central opening 174; wherein the first circumferential distance is different from the second circumferential distance.

In an exemplary embodiment as shown in FIGS. 8A and 8B, the assembly comprises the first data storage disk 152; the first spacer ring 150 positioned with its ring surface 148 against the disk surface 156; a second data storage disk 152; and a second spacer ring 150 positioned with its ring surface 148 against a disk surface 156 of the second data storage disk 152. In an exemplary embodiment, a first combination 154 of the first data storage disk 152 and the first spacer ring 150 has a first combination height in the z direction, wherein the first data storage disk 152 has a first rotational orientation with respect to the first spacer ring 150. A second combination 154 of the second data storage disk 152 and the second spacer ring 150 has a second combination height in the z direction, wherein the first combination height is equal to the second combination height. In an exemplary embodiment, changing the first combination so that the first data storage disk 152 has a second rotational orientation with respect to the first spacer ring 150 results in a changed first combination height that is different from the second combination height. In an exemplary embodiment, the changed first combination height results in a target spacing of the first data storage disk with respect to a ramp 136. In an exemplary embodiment, a clamp 118 is configured to maintain the mutual rotational orientations of the first combination and of the second combination.

The illustrations of the embodiments described herein are intended to provide a general understanding of the structure of the various embodiments. The illustrations are not intended to serve as a complete description of all of the elements and features of apparatus and systems that utilize the structures or methods described herein. Features described with respect to any embodiment also apply to any other embodiment. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description. All patent documents mentioned in the description are incorporated by reference.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments employ more features than are expressly recited in each claim. Rather, as the following claims reflect, inventive subject matter may be directed to less than all of the features of any of the disclosed embodiments.

The above-disclosed subject matter is to be considered illustrative, and not restrictive, and the appended claims are intended to cover all such modifications, enhancements, and other embodiments, which fall within the true spirit and scope of the present disclosure. For example, features described with respect to one embodiment may be incorporated into other embodiments. Thus, to the maximum extent allowed by law, the scope of the present disclosure is to be determined by the broadest permissible interpretation of the following claims and their equivalents, and shall not be restricted or limited by the foregoing detailed description.

1. An assembly comprising:
a first data storage disk comprising:
a disk surface defining a x-y plane, wherein the disk surface comprises a plurality of data tracks surrounding a first central opening;
a first disk step disposed proximate the first central opening at a first disk step level measured in a z direction from the disk surface; and
a second disk step disposed proximate the first central opening at a second disk step level measured in the z direction from the disk surface, wherein the first disk step level is different from the second disk step level; and
a first spacer ring comprising:
a ring surface surrounding a second central opening;
a first ring step disposed proximate the second central opening at a first ring step level measured in the z direction from the ring surface; and
a second ring step disposed proximate the second central opening at a second ring step level measured in the z direction from the ring surface; and
wherein in the assembly, the disk surface faces the ring surface.

2. The assembly of claim 1, wherein the first disk step level equals the first ring step level.

3. The assembly of claim 1, wherein the first disk step level is different from the first ring step level.

4. The assembly of claim 1, wherein the second disk step level equals two times the first disk step level.

5. The assembly of claim 1 comprising a groove positioned between the first ring step and the second ring step.

6. The assembly of claim 1, wherein at least one of the first or second disk steps is recessed from the disk surface.

7. The assembly of claim 1, wherein the first disk step is recessed from the disk surface and the second disk step is raised from the disk surface.

8. The assembly of claim 1, wherein the first data storage disk comprises a plurality of arc sections, wherein a first arc section of the plurality of arc sections comprises:
a first portion of the disk surface;
the first disk step adjacent the first portion of the disk surface; and
the second disk step adjacent the first disk step.

9. The assembly of claim 8, wherein the plurality of arc sections repeat in series around the first central opening.

10. The assembly of claim 1, wherein at least one of the first data storage disk or the first spacer ring is symmetrical about a x-axis or a y-axis.

11. The assembly of claim 1, wherein at least one of the first data storage disk or the first spacer ring is symmetrical about both a x-axis and a y-axis.

12. The assembly of claim 1, wherein at least one of the first or second disk steps is rectangular.

13. The assembly of claim 1, wherein:
the first disk step extends a first circumferential distance along the first central opening; and
the second disk step extends a second circumferential distance along the first central opening;
wherein the first circumferential distance is different from the second circumferential distance.

14. The assembly of claim 1, wherein at least one of the first or second disk steps is circular.

15. The assembly of claim 1, wherein at least one of the first or second ring steps is circular.

16. The assembly of claim 1 comprising:
the first data storage disk;
the first spacer ring positioned with its ring surface against the disk surface;
a second data storage disk; and
a second spacer ring positioned with its ring surface against a disk surface of the second data storage disk.

17. The assembly of claim 16, wherein:
a first combination of the first data storage disk and the first spacer ring has a first combination height in the z direction, wherein the first data storage disk has a first rotational orientation with respect to the first spacer ring; and
a second combination of the second data storage disk and the second spacer ring has a second combination height in the z direction;
wherein the first combination height is equal to the second combination height.

18. The assembly of claim 17, wherein changing the first combination so that the first data storage disk has a second rotational orientation with respect to the first spacer ring results in a changed first combination height that is different from the second combination height.

19. The assembly of claim 18 comprising a ramp, wherein the changed first combination height results in a target spacing of the first data storage disk with respect to the ramp.

20. The assembly of claim 19 comprising a clamp that is configured to maintain mutual rotational orientations of the first combination and of the second combination.
